(19) United States
(12) Patent Application Publication
(10) Pub. No.: US 2021/0340359 A1
(43) Pub. Date: Nov. 4, 2021

(54) RUBBER COMPOSITION

(71) Applicant: COMPAGNIE GENERALE DES ETABLISSEMENTS MICHELIN, Clermont-Ferrand (FR)

(72) Inventors: Aurore CROCHET, Clermont-Ferrand Cedex 9 (FR); Frédéric LEMERLE, Clermont-Ferrand Cedex 9 (FR); José-Carlos ARAUJO DA SILVA, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 17/282,614

(22) PCT Filed: Oct. 3, 2019
(86) PCT No.: PCT/FR2019/052340

§ 371 Date: Apr. 2, 2021

(30) Foreign Application Priority Data
Oct. 9, 2018 (FR) FR1859357

(51) Int. Cl. C08L 7/00; B60C 1/00

(52) U.S. Cl. CPC C08L 7/00; C08L 2205/06; C08L 2312/00; B60C 1/0025

(57) ABSTRACT

A rubber composition based at least on natural rubber, on a copolymer of ethylene and of a 1,3-diene, on a carbon black and on a crosslinking system, is provided. The natural rubber content in the rubber composition is greater than 50 phr, the ethylene units in the copolymer represent more than 50 mol % of the monomer units of the copolymer. Such a rubber composition exhibits an improved compromise between the properties of cohesion and resistance to ozone.

This application is a 371 national phase entry of PCT/FR2019/052340 filed on 3 Oct. 2019, which claims benefit of French Patent Application No. 1859357, filed 9 Oct. 2018, the entire contents of which are incorporated herein by reference for all purposes.

### BACKGROUND

### 1. Technical Field

The field of the present invention is that of rubber compositions reinforced with carbon black and comprising a highly saturated diene elastomer, the rubber compositions being particularly intended for use in a tire, more particularly in a tire sidewall.

### 2. Related Art

A tire usually comprises two beads intended to come into contact with a rim, a crown composed of at least one crown reinforcement and a tread, and two sidewalls, the tire being reinforced by a carcass reinforcement anchored in the two beads. A sidewall is an elastomeric layer positioned outside the carcass reinforcement relative to the internal cavity of the tire, between the crown and the bead, so as to completely or partially cover the region of the carcass reinforcement extending from the crown to the bead.

In the conventional manufacture of a tire, the various constituent components of the crown, of the carcass reinforcement, of the beads and of the sidewalls are assembled to form a pneumatic tire. The assembly step is followed by a step of forming the tire so as to give the assembly the toric shape before the in-press curing step. The sidewalls are exposed both to the action of ozone and to cycles of deformation such as bending during the running of the tire. The deformation cycles combined with the action of ozone can cause cracks or fissures to appear in the sidewall, preventing the use of the tire regardless of the wear of the tread. Consequently, rubber compositions are sought which are very cohesive in order to constitute, for example, tire sidewalls by virtue of their capacity to undergo large deformations without breaking, even in the presence of a crack initiation.

To minimize the action of ozone on rubber compositions, it is known to use copolymers exhibiting less sensitivity to oxidation, such as, for example, highly saturated diene elastomers, elastomers comprising ethylene units at a molar content of greater than 50 mol % of the monomer units of the elastomer. Mention may be made, for example, of copolymers of ethylene and of 1,3-diene which contain more than 50 mol % of ethylene, in particular copolymers of ethylene and of 1,3-butadiene. The use of such copolymers of ethylene and of 1,3-butadiene in a tread of a tire is for example described in document WO 2014/114607 A1 and has the effect of conferring on the tire good wear resistance and rolling resistance properties. The use of copolymers of ethylene and of 1,3-diene in a composition for sidewalls is also, for example, described in document EP 2682423 A1 for increasing resistance to ozone. Nevertheless, a deterioration of the cohesion properties of the rubber composition occurs as soon as the molar content of ethylene in the copolymer is greater than 50%.

### SUMMARY

The applicant has discovered a rubber composition comprising a copolymer of ethylene and of 1,3-diene with a molar content of ethylene of greater than 50% which exhibits an improved compromise between the properties of cohesion and resistance to ozone.

Thus, a first subject of the invention is a rubber composition based at least on natural rubber, on a copolymer of ethylene and of a 1,3-diene, on a carbon black and on a crosslinking system, the natural rubber content in the rubber composition being greater than 50 phr, the ethylene units in the copolymer representing more than 50 mol % of the monomer units of the copolymer.

A second subject of the invention is a tire which comprises a rubber composition in accordance with the invention, preferably in a portion or all of a sidewall of the tire.

### I. DETAILED DESCRIPTION OF EXAMPLE EMBODIMENTS

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b). The abbreviation “phr” means parts by weight per hundred parts of elastomer (of the total of the elastomers if several elastomers are present).

In the present description, the expression “composition based on” should be understood as meaning a composition including the mixture and/or the product of the in situ reaction of the various constituents used, some of these base constituents (for example the elastomer, the filler or the constituents of the vulcanizing system or other additive conventionally used in a rubber composition intended for the manufacture of a tire) being liable or intended to react together, at least partly, during the various phases of manufacture of the composition intended for the manufacture of a tire.

In the present patent application, the expression “all of the monomer units of the elastomer” or “the total amount of the monomer units of the elastomer” means all the constituent repeating units of the elastomer which result from the insertion of the monomers into the elastomer chain by polymerization. Unless otherwise indicated, the contents of a monomer unit or repeating unit in the highly saturated diene elastomer are given as molar percentages calculated on the basis of all of the monomer units of the elastomer.

The compounds mentioned in the description may be of fossil or biobased origin. In the latter case, they may be partially or completely derived from biomass or may be obtained from renewable starting materials derived from biomass. Elastomers, plasticizers, fillers and the like are notably concerned.

The copolymer of ethylene and of 1,3-diene which is useful for the purposes of the invention is a preferably random elastomer which comprises ethylene units resulting from the polymerization of ethylene. In a known way, the expression “ethylene unit” refers to the —(CH₂—CH₂)— unit resulting from the insertion of ethylene into the elastomer chain. In the copolymer of ethylene and of 1,3-diene, the ethylene units represent more than 50 mol % of the monomer units of the copolymer. Preferably, the ethylene units in the copolymer represent more than 60 mol %, advantageously more than 70 mol % of the monomer units of the copolymer. According to any one of the embodiments of the invention, including their preferential variants, the highly saturated diene elastomer preferentially comprises at most 90 mol % of ethylene unit.

The copolymer which is useful for the purposes of the invention, also referred to below under the name highly saturated diene elastomer, also comprises 1,3-diene units resulting from the polymerization of a 1,3-diene. In a known manner, the term “1,3-diene unit” refers to units resulting from the insertion of the 1,3-diene via a 1,4 addition, a 1,2 addition or a 3,4 addition in the case of isoprene. The 1,3-diene units are those, for example, of a 1,3-diene or of a mixture of 1,3-dienes, the 1,3-diene(s) having 4 to 12 carbon atoms, such as most particularly 1,3-butadiene and isoprene. Preferably, the 1,3-diene is 1,3-butadiene.

According to a first embodiment of the invention, the copolymer of ethylene and of a 1,3-diene contains units of formula (I). The presence of a saturated 6-membered cyclic unit, 1,2-cyclohexanediyl, of formula (I) as a monomer unit in the copolymer can result from a series of very particular insertions of ethylene and 1,3-butadiene in the polymer chain during its growth.

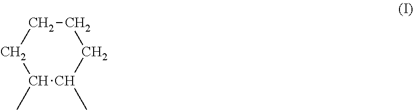

According to a second preferential embodiment of the invention, the copolymer of ethylene and of a 1,3-diene contains units of formula (II).

—CH₂—CH(CH═CH₂)— (II)

According to a third preferential embodiment of the invention, the copolymer of ethylene and of a 1,3-diene contains units of formula (I) and of formula (II).

According to a fourth embodiment of the invention, the highly saturated diene elastomer is devoid of units of formula (I). According to this fourth embodiment, the copolymer of ethylene and of a 1,3-diene preferably contains units of formula (II).

When the highly saturated diene elastomer comprises units of formula (I) or units of formula (II) or else units of formula (I) and units of formula (II), the molar percentages of units of formula (I) and of units of formula (II) in the highly saturated diene elastomer, respectively o and p, preferably satisfy the following equation (eq. 1), more preferentially satisfy the equation (eq. 2), o and p being calculated on the basis of all the monomer units of the highly saturated diene elastomer.

0<o+p≤25 (eq. 1)

0<o+p<20 (eq. 2)

According to the first embodiment, according to the second embodiment of the invention, according to the third embodiment and according to the fourth embodiment, including the preferential variants thereof, the highly saturated diene elastomer is preferentially a random copolymer.

The highly saturated diene elastomer, in particular according to the first embodiment, according to the second embodiment, according to the third embodiment and according to the fourth embodiment, can be obtained according to various synthesis methods known to those skilled in the art, in particular as a function of the intended microstructure of the highly saturated diene elastomer. Generally, it may be prepared by copolymerization at least of a 1,3-diene, preferably 1,3-butadiene, and of ethylene and according to known synthesis methods, in particular in the presence of a catalytic system comprising a metallocene complex. Mention may be made, in this respect, of catalytic systems based on metallocene complexes, which catalytic systems are described in documents EP 1092731, WO 2004/035639, WO 2007/054223 and WO 2007/054224 on behalf of the applicant. The highly saturated diene elastomer, including the case when it is random, may also be prepared via a process using a catalytic system of preformed type such as those described in WO 2017/093654 A1, WO 2018/020122 A1 and WO 2018/020123 A1.

The highly saturated diene elastomer may consist of a mixture of copolymers of ethylene and of 1,3-diene which differ from each other by virtue of their microstructures or their macrostructures.

According to the first embodiment of the invention, according to the second embodiment of the invention, according to the third embodiment and according to the fourth embodiment, the highly saturated diene elastomer is preferably a copolymer of ethylene and of 1,3-butadiene, more preferentially a random copolymer of ethylene and of 1,3-butadiene.

The essential feature of the rubber composition according to the invention is that it comprises more than 50 phr of natural rubber. Preferably, the natural rubber content in the rubber composition is greater than 55 phr and less than or equal to 80 phr. More preferentially, it varies in a range extending from 60 to 80 phr.

The content of copolymer of ethylene and of a 1,3-diene which is useful for the purposes of the invention, in particular of copolymer of ethylene and of 1,3-butadiene, in the rubber composition preferably varies within a range extending from 20 to 40 phr.

Advantageously, the rubber composition comprises from 20 to 40 phr of copolymer of ethylene and of 1,3-diene, in particular of copolymer of ethylene and of 1,3-butadiene, and from 60 to 80 phr of natural rubber.

The rubber composition which is useful for the purposes of the invention has the essential feature of comprising a carbon black as a reinforcing filler. A reinforcing filler typically consists of nanoparticles of which the mean (mass-average) size is less than a micrometre, generally less than 500 nm, usually between 20 and 200 nm, in particular and more preferentially between 20 and 150 nm. Preferably, the carbon black content in the rubber composition is within a range extending from 25 phr to 65 phr. Below 25 phr, the level of reinforcement may prove to be insufficient for certain applications of the rubber composition in the tire. Above 65 phr, the rubber composition may become too stiff for certain applications of the rubber composition in the tire. For example, for an application of the rubber composition in a tire sidewall, the carbon black content is advantageously within a range extending from 25 phr to 65 phr.

Any carbon black, notably the blacks conventionally used in tires or their treads (known as tire-grade blacks), is suitable for use as carbon blacks. Among the latter, mention will be made more particularly of the reinforcing carbon blacks of the 100, 200 and 300 series, or the blacks of the 500, 600 or 700 series (ASTM grades), for instance the N115, N134, N234, N326, N330, N339, N347, N375, N550, N683 and N772 blacks. When the rubber composition in accordance with the invention is used in a tire sidewall, the carbon black is preferentially a carbon black of the 300 series or a carbon black having a BET specific surface area ranging from 70 m²/g to 100 m²/g. It should be noted that the BET specific surface area can be measured according to standard ASTM D6556-09 [multipoint method (5 points)—gas: nitrogen—relative pressure range P/P0: 0.05 to 0.30].

The crosslinking system may be based either on sulfur or on sulfur donors and/or on peroxide and/or on bismaleimides. Preferably, the crosslinking system is preferentially a vulcanization system, i.e. a system based on sulfur (or on a sulfur-donating agent) and on a vulcanization accelerator. Use may be made, as vulcanization accelerator, of any compound capable of acting as accelerator of the vulcanization of diene elastomers in the presence of sulfur, in particular accelerators of the thiazole type, and also their derivatives, or accelerators of sulfenamide, thiuram, dithiocarbamate, dithiophosphate, thiourea and xanthate types. By way of examples of such accelerators, mention may be made in particular of the following sulfenamides: N-cyclohexyl-2-benzothiazole sulfenamide (“CBS”), N,N-dicyclohexyl-2-benzothiazole sulfenamide (“DCBS”), N-tert-butyl-2-benzothiazole sulfenamide (“TBBS”) and mixtures of these compounds.

The sulfur is used at a preferential content of between 0.3 phr and 10 phr, more preferentially between 0.3 and 5 phr. The primary vulcanization accelerator is used at a preferential content of between 0.5 and 10 phr, more preferentially of between 0.5 and 5 phr.

The crosslinking (or curing), where appropriate the vulcanization, is carried out in a known manner at a temperature generally of between 130° C. and 200° C., for a sufficient time which may vary, for example, between 5 and 90 min, depending especially on the curing temperature, on the crosslinking system adopted and on the crosslinking kinetics of the composition in question.

The rubber composition which is useful for the purposes of the invention may also comprise all or some of the usual additives normally used in elastomer compositions intended for use in a tire, such as, for example, processing agents, plasticizers, pigments, protective agents such as anti-ozone waxes, chemical anti-ozonants, antioxidants. Suitable plasticizers are all the plasticizers conventionally used in tires. In this respect, mention may be made of oils which are preferentially non-aromatic or very weakly aromatic, chosen from the group consisting of naphthenic oils, paraffinic oils, MES oils, TDAE oils, plant oils, ether plasticizers, ester plasticizers.

When the rubber composition constitutes part or all of the sidewalls of a tire, it preferably comprises a plasticizer, the content of which in the rubber composition is adjusted to provide the stiffness suitable for use in a sidewall. Typically, the amount of plasticizer then ranges from 20 phr to 60 phr for a carbon black content within a range extending from 25 phr to 65 phr. Preferably, the amount of plasticizer ranges from 20 to 50 phr.

The rubber composition may be manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 110° C. and 190° C., preferably between 130° C. and 180° C., followed by a second phase of mechanical working (sometimes referred to as a “productive” phase) at lower temperature, typically below 110° C., for example between 40° C. and 100° C., during which finishing phase the sulfur or the sulfur donor and the vulcanization accelerator are incorporated.

By way of example, the first phase (non-productive) is performed as a single thermomechanical step during which all the necessary constituents, the optional additional processing agents and the other various additives, with the exception of the sulfur and the vulcanization accelerator, are introduced into a suitable mixer such as a conventional internal mixer. The total kneading time in this non-productive phase is preferably between 1 and 15 minutes. After cooling the mixture thus obtained during the first non-productive phase, the sulfur and the vulcanization accelerator are then incorporated at low temperature, generally into an external mixer such as an open mill; the whole is then mixed (productive phase) for a few minutes, for example between 2 and 15 minutes.

The final composition thus obtained is subsequently calendered, for example in the form of a sheet or slab, in particular for laboratory characterization, or else extruded, in order to form, for example, a rubber profiled element used in the manufacture of semi-finished products, such as tire sidewalls.

The tire, another subject of the invention, comprises a rubber composition in accordance with the invention. Preferably, the tire comprises a sidewall, a portion or all of which consists of a rubber composition in accordance with the invention, which composition preferably comprises a plasticizer. More preferably, in the tire in accordance with the invention, the rubber composition comprising a plasticizer constitutes the sidewalls of the tire. According to this more preferential embodiment of the invention and for a carbon black content in a range extending from 25 phr to 65 phr, the amount of plasticizer ranges from 20 phr to 60 phr, advantageously from 20 phr to 50 phr. According to a variant of this more preferential embodiment of the invention, the carbon black has a BET specific surface area ranging from 70 m²/g to 100 m²/g.

The rubber composition and the tire in accordance with the invention can be in the uncured state (that is to say before crosslinking) or in the cured state (that is to say after crosslinking).

The abovementioned characteristics of the present invention, and also others, will be understood more clearly on reading the following description of several implementation examples of the invention, which are given as non-limiting illustrations.

### II. EXAMPLES OF IMPLEMENTATION OF THE INVENTION

### II.1 Tests and Measurements:

### II.1-1 Determination of the Microstructure of the Elastomers:

The microstructure of the elastomers is determined by ¹H NMR analysis, compensated for by the ¹³C NMR analysis when the resolution of the ¹H NMR spectra does not make it possible to assign and quantify all the entities. The measurements are performed using a Brüker 500 MHz NMR spectrometer at frequencies of 500.43 MHz for proton observation and 125.83 MHz for carbon observation.

For the insoluble elastomers which have the capacity of swelling in a solvent, a 4 mm z-grad HRMAS probe is used for proton and carbon observation in proton-decoupled mode. The spectra are acquired at rotational speeds of from 4000 Hz to 5000 Hz.

For the measurements on soluble elastomers, a liquid NMR probe is used for proton and carbon observation in proton-decoupled mode.

The preparation of the insoluble samples is performed in rotors filled with the analysed material and a deuterated solvent enabling swelling, generally deuterated chloroform (CDCl3). The solvent used must always be deuterated and its chemical nature may be adapted by those skilled in the art. The amounts of material used are adjusted so as to obtain spectra of sufficient sensitivity and resolution.

The soluble samples are dissolved in a deuterated solvent (about 25 mg of elastomer in 1 mL), generally deuterated chloroform (CDCl3). The solvent or solvent blend used must always be deuterated and its chemical nature may be adapted by those skilled in the art.

In both cases (soluble sample or swollen sample):

A 30° single pulse sequence is used for proton NMR. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

A 30° single pulse sequence is used for carbon NMR, with proton decoupling only during the acquisition to avoid nuclear Overhauser effects (NOE) and to remain quantitative. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

The NMR measurements are performed at 25° C.

### II. 1-2 Mechanical Strength in the Presence of a Crack Initiator (Tearability):

The tearability strength and deformation are measured on a specimen drawn at 500 mm/minute to bring about breaking of the specimen. The tensile test specimen is composed of a rubber slab of parallelepipedal shape, for example with a thickness of between 1 and 2 mm, with a length between 130 and 170 mm and with a width between 10 and 15 mm, the two side edges each being covered in the direction of the length with a cylindrical rubber strip (diameter 5 mm) making possible anchoring in the jaws of the tensile testing device. 3 very fine notches of length between 15 and 20 mm are made using a razor blade, at mid-width and aligned in the direction of the length of the test piece, one at each end and one in the centre of the latter, before starting the test. The force (N/mm) to be exerted in order to obtain breaking is determined and the elongation at break and the breaking stress are measured. The test was carried out in air at a temperature of 100° C. The higher the values of deformation and force at break or energy at break, the better the resistance to crack propagation of the rubber composition despite having crack initiators, which reflects good cohesion of rubber composition. The results are given in base 100 relative to a control.

### II.1-3 Tensile Tests:

The elongation at break (EB %) and breaking stress (BS) tests are based on the standard NF ISO 37 of December 2005 on an H2 dumbbell specimen and are measured at a tensile speed of 500 mm/min. The elongation at break is expressed as a percentage of elongation. The breaking stress is expressed in MPa. All these tensile measurements are carried out at 60° C. The results are given in base 100 relative to a control.

### II.1-4 Resistance to Ozone:

Ozone resistance was evaluated using the trapezoid test where cracking is determined after elongation of the sample under static conditions. Samples subjected to a stress are more likely to crack. The samples have a dog bone shape and were cut with a die and loaded into a V-shaped holder. The V-shaped holder makes it possible to obtain sample strains of 10% to 150%. The V-shaped holder with the samples is placed in an ozone chamber. The conditions of the ozone chamber were set at 50 parts per hundred million of ozone (pphm) and at a temperature of 38° C. for 144 h. The results of the trapezoid tests indicate the elongation at which the first cracks appeared. The higher the elongation at which the cracks appear, the more resistant the material is to ozone cracking.

### II.2 Preparation of the Rubber Compositions:

Four rubber compositions C1 to C4, the formulation details of which appear in Table 1, were prepared as follows:

The elastomers, the carbon black and the various other ingredients except for the sulfur and the vulcanization accelerator are successively introduced into an internal mixer (final degree of filling: approximately 70% by volume), the initial tank temperature of which is approximately 80° C. Thermomechanical working (non-productive phase) is then performed in one step, which lasts in total approximately 3 to 4 min, until a maximum “dropping” temperature of 165° C. is reached. The mixture thus obtained is recovered and cooled, and sulfur and the vulcanization accelerator are then incorporated on a mixer (homofinisher) at 30° C., the whole being kneaded (productive phase) for an appropriate time (for example approximately ten minutes).

The compositions thus obtained are then calendered either in the form of plates (thickness 2 to 3 mm) or of thin sheets of rubber for the measurement of their physical or mechanical properties, or extruded to form for example a profile for a tire.

The four rubber compositions contain a highly saturated diene elastomer with a molar ethylene content greater than 50% and natural rubber. The rubber compositions C1 and C2 are not in accordance with the invention, since the natural rubber content is 40 phr and 50 phr respectively. The rubber compositions C3 and C4 are in accordance with the invention, the level of natural rubber being greater than 50 phr.

The highly saturated diene elastomer (EBR) is prepared according to the following procedure: 30 mg of metallocene [{Me₂SiFlu₂Nd(μ-BH₄)₂Li(THF)}₂, the symbol Flu representing the fluorenyl group of formula C₁₃H₈], are introduced into a first Steinie bottle in a glovebox. The co-catalyst, butyloctylmagnesium dissolved beforehand in 300 ml of methylcyclohexane in a second Steinie bottle, is introduced into the first Steinie bottle containing the metallocene in the following proportions: 0.00007 mol/L of metallocene, 0.0004 mol/L of co-catalyst. After contact for 10 minutes at ambient temperature, a catalytic solution is obtained. The catalytic solution is then introduced into the polymerization reactor. The temperature in the reactor is then increased to 80° C. When this temperature is reached, the reaction starts by injection of a gaseous mixture of ethylene and 1,3-butadiene (80/20 mol %) into the reactor. The polymerization reaction proceeds at a pressure of 8 bar. The proportions of metallocene and of co-catalyst are, respectively, 0.00007 mol/L and 0.0004 mol/L. The polymerization reaction is stopped by cooling, degassing of the reactor and addition of ethanol. An antioxidant is added to the polymer solution. The copolymer is recovered by drying in a vacuum oven.

### II.3 Results:

The results are given in Table 1. With the exception of the score assigned to quantify the severity of the ozone attack, the results are shown as a performance index relative to a control. Since the value of the control, composition C2, is arbitrarily set at 100, a value greater than 100 indicates improved performance.

The results show that the rubber compositions C3 and C4 are the rubber compositions which exhibit the best cohesion: both the tensile elongations at break and the tearability energy at break are the best compared to the control C2 and compared to the composition C1.

The good cohesion properties obtained with the compositions comprising a highly saturated diene elastomer and enriched with natural rubber (composition F1 to F3) make it possible to envisage their use as a tire sidewall, as shown by the results of Table 2 compared to a control rubber composition (composition T) conventionally used in tire sidewalls.

Tires of which the sidewalls consist of the compositions in accordance with the invention, such as C3 and C4, have completely improved performance and are particularly suitable for being fitted to passenger vehicles or heavy goods vehicles.

Indeed, the rubber compositions F1, F2 and F3 in accordance with the invention and constituting the sidewalls of a tire give the tire improved performance while maintaining the ozone resistance performance at a high level.

TABLE 1

| | C1 not in | C2 not in | C3 in | C4 in |
|---|---|---|---|---|
| | accordance | accordance | accordance | accordance |
| | with the | with the | with the | with the |
| | invention | invention | invention | invention |
| Composition | | | | |
| EBR (1) | 60 | 50 | 40 | 20 |
| NR (2) | 40 | 50 | 60 | 80 |
| Carbon black (3) | 40 | 40 | 40 | 40 |
| Antioxidant (4) | 2 | 2 | 2 | 2 |
| Anti-ozone wax | 1 | 1 | 1 | 1 |
| Stearic acid | 1.5 | 1.5 | 1.5 | 1.5 |
| ZnO | 2.5 | 2.5 | 2.5 | 2.5 |
| Accelerator (5) | 1.2 | 1.2 | 1.2 | 1.2 |
| Sulfur | 0.5 | 0.5 | 0.5 | 0.5 |
| Properties in the | | | | |
| cured state | | | | |
| Tensile | 90 | 100 | 115 | 120 |
| Elongation at break | | | | |
| Tearability | 106 | 100 | 235 | 397 |
| Energy at break | | | | |

(1) Elastomer containing 79 mol % of ethylene units, 7 mol % of 1,2-cyclohexanediyl units, 8 mol % of 1, 2 units of the butadiene part, and 6 mol % of 1, 4 units of the butadiene part
(2) Natural rubber
(3) N234
(4) N-(1,3-Dimethylbutyl)-N′-phenyl-p-phenylenediamine (Santoflex 6-PPD from the company Flexsys)
(5) N-Cyclohexyl-2-benzothiazolesulfenamide (Santocure CBS from the company Flexsys)

TABLE 2

| | T | F1 | F2 | F3 |
|---|---|---|---|---|
| Sidewall composition | | | | |
| NR (1) | 50 | 60 | 60 | 60 |
| BR (2) | 50 | | | |
| EBR (3) | | 40 | 40 | 40 |
| Carbon black (4) | 50 | 50 | 55.5 | 59.5 |
| Plasticizers | 20 | 20 | 34 | 44 |
| Antioxidant (5) | 5 | 5 | 5 | 5 |
| Stearic acid | 2 | 2 | 2 | 2 |
| ZnO | 3 | 3 | 3 | 3 |
| Accelerator (6) | 1 | 1 | 1 | 1 |
| Sulfur | 2 | 2 | 2 | 2 |
| Properties in the | | | | |
| cured state | | | | |
| Elongation at break | 100 | 113 | 109 | 104 |
| (tensile) | | | | |
| Tearability | | | | |
| Strain at break | 100 | 135 | 160 | 163 |
| Breaking strength | 100 | 165 | 152 | 136 |
| Ozone resistance | 100 | 180 | 120 | 80 |
| Minimum elongation | | | | |

(1) Natural rubber
(2) Polybutadiene CB 24 from Lanxess with 96% (mol %) of cis
(3) Elastomer containing 79 mol % of ethylene units, 7 mol % of 1,2-cyclohexanediyl units, 8 mol % of 1, 2 units of the butadiene part, and 6 mol % of 1, 4 units of the butadiene part
(4) N330
(5) N-(1,3-Dimethylbutyl)-N′-phenyl-p-phenylenediamine (Santoflex 6-PPD from the company Flexsys)
(6) N-Cyclohexyl-2-benzothiazolesulfenamide (Santocure CBS from the company Flexsys)

1. A rubber composition based at least on natural rubber, on a copolymer of ethylene and of a 1,3-diene, on a carbon black and on a crosslinking system, the natural rubber content in the rubber composition being greater than 50 phr, the ethylene units in the copolymer representing more than 50 mol % of the monomer units of the copolymer.

2. The rubber composition according to claim 1 in which the ethylene units in the copolymer represent more than 60 mol % of the monomer units of the copolymer.

3. The rubber composition according to claim 1, in which the content of copolymer of ethylene and of a 1,3-diene varies in a range extending from 20 to 40 phr.

4. The rubber composition according to claim 1, in which the natural rubber content is greater than 55 phr and less than or equal to 80 phr.

5. The rubber composition according to claim 1, in which the 1,3-diene is 1,3-butadiene.

6. The rubber composition according to claim 1, in which the copolymer contains units of formula (I) or units of formula (II) or else units of formula (I) and of formula (II):

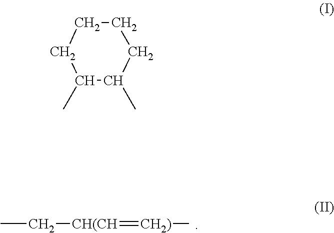

7. The rubber composition according to claim 6, in which the molar percentages of the units of formula (I) and of the units of formula (II) in the copolymer, respectively o and p, satisfy the following equation (eq. 1), o and p being calculated on the basis of all the monomer units of the copolymer:
0<o+p≤25 (eq. 1)

8. The rubber composition according to claim 1, in which the copolymer is a random copolymer.

9. The rubber composition according to claim 1, in which the carbon black content is within a range extending from 25 phr to 65 phr.

10. The rubber composition according to claim 1, in which the crosslinking system is a vulcanization system.

11. A tire which comprises the rubber composition defined in claim 1.

12. The tire according to claim 11, in which the rubber composition constitutes the sidewalls of the tire and comprises a plasticizer.

13. The tire according to claim 12, in which the amount of plasticizer ranges from 20 phr to 60 phr for a carbon black content within a range extending from 25 phr to 65 phr.

14. The tire according to claim 13, in which the amount of plasticizer ranges from 20 to 50 phr.

15. The tire according to claim 11, in which the carbon black has a BET specific surface area ranging from 70 m²/g to 100 m²/g.

16. The rubber composition according to claim 2 in which the ethylene units in the copolymer represent more than 70 mol % of the monomer units of the copolymer.

17. The rubber composition according to claim 4, in which the natural rubber content is within a range extending from 60 to 80 phr.

18. The rubber composition according to claim 7, in which the molar percentages of the units of formula (I) and of the units of formula (II) in the copolymer, respectively o and p, satisfy the following equation (eq. 2), o and p being calculated on the basis of all the monomer units of the copolymer:
0<o+p<20 (eq. 2).

19. The tire according to claim 11, in which the rubber composition is in a portion or all of a sidewall of the tire.
